(19) United States
(12) Patent Application Publication
(10) Pub. No.: US 2017/0214118 A1
(43) Pub. Date: Jul. 27, 2017

(54) MOBILE RADIO ANTENNA FOR A SMALL RECEIVER

(71) Applicant: Orange, Paris (FR)

(72) Inventors: Martin Conan, Cesson Sevigne (FR); Renaud Cazoulat, Saint Gregoire (FR)

(73) Assignee: Orange, Paris (FR)

(21) Appl. No.: 15/515,495

(22) PCT Filed: Sep. 30, 2015
(86) PCT No.: PCT/FR2015/052620

§ 371 Date: Mar. 29, 2017

(30) Foreign Application Priority Data
Sep. 30, 2014 (FR) 1459260

(51) Int. Cl. H01Q 1/22; H01Q 1/46

(52) U.S. Cl. CPC H01Q 1/2275; H01Q 1/46; H01Q 1/2291

(57) ABSTRACT

A system includes a terminal and at least one cable. The terminal includes a module for transmitting and/or receiving data to be played back on a playback device, where the data is received or transmitted by at least one antenna. The terminal also includes a module for connecting to the playback device via a communication medium and a module for connecting to a power supply device via a power supply medium. The cable includes the antenna, at least one of the communication and/or power supply medium, and a connector for connecting the cable to the terminal, where the antenna is electrically independent of the connector.

### TECHNICAL FIELD

The invention relates to the reception and the transmission of radiofrequency signals.

The invention applies to any terminal equipped with a transmission-reception module of radiofrequency type requiring an antenna.

### STATE OF THE ART

To display signals of audiovisual nature (television, music, etc.) on a playback terminal, it is necessary for the latter to be equipped with an antenna for the reception, and possibly the transmission, of broadcast radio waves carrying the electrical signals.

These terminals are being increasingly miniaturized; examples that can be cited include smartphones, or the small terminals intended for televisions for downloading and decoding audiovisual programs on an internet network, which take the form of small units or of dongles to be connected to the television. In such a case, the restricted space on the terminal does not make it possible to have an antenna of adequate size for good quality reception.

There are in fact antennas of reduced size, for example consisting of a metal wire arranged on a small printed circuit. These antennas present a certain number of drawbacks: first of all, such an antenna exhibits a reception quality lower than that of the larger antennas. If the reception quality is inadequate, the bit rate necessary for the correct playback of the audiovisual content cannot be achieved, which is reflected by a certain number of annoying problems in the playback on the television (image not received, degraded, frozen, sound distorted, etc.); in addition, the arrangement of the antenna cannot be modified, although it is well known that a change of orientation of such an antenna often makes it possible to considerably increase the reception quality; moreover, in the case where two antennas are desirable, notably to enhance the reception, it is necessary to observe a certain separation between them, which is not possible with this type of antenna since the medium (the terminal) imposes size constraints.

It must also be noted that some terminals of this type, for example the dongles, are placed behind the televisions, which reduces the sensitivity and therefore the efficiency of their antenna.

It is known practice to leave the antenna trailing outside of the receiver. However, such a solution makes the device difficult to handle (since the antenna, generally welded, hangs outside of the terminal). In addition, such an antenna is brittle. Finally, this type of solution does not make it possible to best orient the antenna, which is subject to gravity.

To avoid these kinds of drawbacks, it has been proposed to re-use certain existing wires of an electrical cable to transport the antenna signal. For example, it is known practice, from the application EP 2 712 024 A1, to modify a serial cable of USB (Universal Serial Bus) type connected to the terminal to have the antenna signal pass over one of the pins of the USB connector. This solution is complex to implement since it requires an adaptation of the existing USB cable (by the addition, in particular, of suitable electronic circuits). It is also limited to the cables of USB type. In addition, the antenna thus provided does not supply a signal of good quality, the electrical wires of the USB cable not being designed to transport radio signals. Furthermore, the simultaneous transport of data during the standard operation of the USB disturbs the antenna signal and thus reduces its efficiency.

The invention offers a solution that does not present the drawbacks of the prior art.

The invention

To this end, according to a hardware aspect, the subject of the invention is a system comprising a terminal and at least one cable,

the terminal comprising:
a module for transmitting-receiving data to be played back on a playback device, said data being received or transmitted by at least one antenna;
a module for connecting to the playback device via a communication medium capable of exchanging data with the playback device;
a module for connecting to a power supply device via a power supply medium capable of transporting an electrical power supply,

the cable comprising:
the communication and/or power supply medium;
a connector for connecting it to the terminal,

characterized in that the cable further comprises said antenna and in that the antenna is electrically independent of the connector.

The term module can correspond equally to a software component and to a hardware component or a set of hardware and software components, a software component itself corresponding to one or more computer programs or routines or, more generally, to any element of a program capable of implementing a function or a set of functions as described for the modules concerned. Similarly, a hardware component corresponds to any element of a hardware assembly capable of implementing a function or a set of functions for the module concerned (integrated circuit, chip card, memory card, etc.).

An antenna is understood here, conventionally, to be one or more devices making it possible to radiate (transmitter) or to pick up (receiver), the radiofrequency waves. The antenna converts electrical quantities existing in a conductor or a transmission line (voltage and current) into electromagnetic quantities in space (electrical field and magnetic field), doing so in transmission and the reverse in reception. The form and the dimensions of an antenna are extremely variable. An antenna for receiving television signals can for example take the form of a metal rake or of a coaxial cable.

A “cable” should be understood here to mean a bundle of wires protected by an insulating jacket, or sheath. The cable can itself be made up of several cables, or a set of wires, each providing a particular function (communication, power supply, etc.), linking the two ends of the cable and capable of supporting a standardized protocol (HDMI, for “High Definition Media Interface”, MHL, for “Mobile High definition Link”, USB for “Universal Serial Bus”, etc.).

A power supply medium should be understood to be a cable transporting at least one power supply means for the terminal. Any cable supporting an electrical power supply can be used: serial cable of USB type, electrical cable, telephone cable, Ethernet cable, audiovisual data transmission cable of MHL type, etc.

A communication medium should be understood to mean a means of communication for the terminal. Any cable or connector offering an exchange of data can be used: serial cable or connector of USB type, telephone cable or connector, Ethernet cable or connector, audiovisual data transmission cable or connector of HDMI or MHL type, etc.

A connector should be understood to be a device capable of ensuring the connection of electrical cables subject to currents of more or less high intensity, at the end of the cable. In particular, the computer connectors, also called “input-output connectors”, are interfaces that make it possible to link equipment items using cables. They generally comprise a male plug with protruding pins, that are inserted into female sockets, made up of accommodating bushes. The pins and bushes of the connectors are generally linked to electrical wires that make up the cable. The association of the pins with each wire of the cable is called pin layout. Each numbered pin corresponds as a general rule to a wire of the cable, but sometimes one of the pins, and the corresponding wire, if present, may not be used.

According to the known prior art, the Wi-Fi antenna of a small transceiver terminal like a dongle is generally situated in the terminal (printed circuit comprising, for example, a metal wire).

The invention, by introducing the antenna into the communication or power supply cable, offers the advantage of moving it into a cable which is already used to transport the electrical power supply of the terminal or data to be played back, and which is therefore necessary in the system. To produce the invention it is sufficient to arrange the electrical power supply and/or the communication cable and the antenna in one and the same sheath, or to have the antenna cable run in the existing sheath of the electrical cable. This is in particular very advantageous in the case of the Wi-Fi systems.

Advantageously, the antenna does not modify the electrical characteristics of the connector of the cable, that is to say that it does not use the active wires of the cable (those which are used for example to transport data or for the power supply) to convey the radio signals. The antenna coexists with the cable but does not use its wires. The invention makes it possible to advantageously pool the cable, which is necessary to the terminal, and therefore always present, and the antenna.

Advantageously, the invention makes it possible, by removing the antenna from the terminal, to reduce the size thereof. It also makes it possible to offer an antenna of better quality, since it is less limited in size, the only limit being the length of the cable. In addition, the antenna can be moved (with the cable which supports it) to enhance the reception or the repeating of the broadcast radio signal according to the location and the orientation of the antenna of the terminal. Finally, the antenna is less brittle, since it is protected by the sheath of the cable and external to the terminal.

The invention can thus be used for radio terminals (radio sets with antenna incorporated in the power supply cable), television terminals (HDMI key making it possible to playback a digital television content on the television to which it is connected), Wi-Fi radio wave retransmission terminals (called “Wi-Fi Modem”), etc.

According to a particular implementation of the invention, a system as described above is characterized in that the antenna is a coaxial cable.

It will be recalled that a coaxial cable is an asymmetrical transmission line or link, used at high frequencies, made up of a cable with two conductors. The central core, which can be single-strand or multi-strand (in copper or in copper-plated steel), is surrounded by a dielectric material (insulator). The dielectric is surrounded by a conductive braid (or wound aluminum sheet), then an insulating and protective sheath. It can be shielded.

The antenna according to this embodiment of the invention is advantageously made up of a single cable whose metal core acts as transceiver.

The characteristics and optimum dimensions of such a coaxial cable are not compatible with the wires usually present in the standard cables (the standard wires of a communication cable notably do not include a shielded core).

The invention therefore provides a substantial advantage over the simple re-use of the existing wires of the cable.

Advantageously, the antenna also does not disturb the communication or power supply cable. As is well known to those skilled in the art, the particular form of the coaxial cable makes it possible to not produce (and not pick up) disturbances on the neighboring signals. The shielding of the electrical wires reduces the emission of electrical fields over the entire length of the circuits.

According to a second particular implementation of the invention, which will be able to be implemented alternatively or together with the preceding one, a system as described above is characterized in that the length of the antenna is matched to the type of signal transported.

Advantageously, the length of the antenna is limited according to the invention only by the length of the cable which bears it. The optimum length of an antenna, for example in coaxial cable form, depends on the wavelength (therefore the frequency) used for the selected radio technology. For example a Bluetooth antenna does not have the same ideal length as a Wi-Fi antenna. It depends also on the mechanical characteristics (the nature of the conductor and its dimensions, the diameters of the sheath and of the central conductor, the nature of the dielectric) and electrical characteristics (its characteristic impedance, its attenuation coefficient, etc.).

Each antenna will thus, according to the invention, be able to be dimensioned to its ideal length by a simple computation within the scope of a person skilled in the art. For the Wi-Fi for example, this length can be of the order of fifteen or so centimeters. In this case, a data or power supply cable of some fifteen centimeters is sufficient to accommodate this cable and transport the radio signal in optimum conditions.

According to a third particular implementation of the invention, which will be able to be implemented alternatively or together with the preceding ones, a system as described above is characterized in that the connector comprises at least one unused pin and in that said at least one antenna leaves the connector via this pin before being linked to the data transmission/reception module.

Advantageously, this embodiment makes it possible to benefit from the electrical connector of the cable without in any way altering its mechanical or electrical behavior. To this end, a free pin of the cable is used to run the antenna cable. The latter emerges on the terminal side and can be easily connected to the antenna signal reception circuit. An example will be given later in the context of the HDMI standard.

Alternatively, a pin specified by the standard, but which is not used in the context of the invention, can be used for the antenna. For example if a USB cable is used only for its power supply (the data being conveyed by an HDMI/MHL cable), the data wires can be used for the antenna. In such a case, the antenna is advantageously connected to the unused wire, or alternatively this wire is removed to leave space for that of the antenna.

According to a fourth particular implementation of the invention, which will be able to be implemented alternatively or together with the preceding ones, a system as described above is characterized in that the cable of USB type comprises the power supply medium.

Advantageously, this embodiment makes it possible to pool the power supply cable, which is necessary to the terminal, and therefore always present, and the antenna.

This embodiment is particularly useful if only the power supply part of a cable of USB type is used, in order to ensure the power supply which is not present in the data cable, for example of HDMI type.

According to a fifth particular implementation of the invention, which will be able to be implemented alternatively or together with the preceding ones, a system as described above is characterized in that the cable of HDMI type comprises the communication medium.

Advantageously, this embodiment makes it possible to pool an audiovisual data transport cable of known type with the reception antenna.

The HDMI (High Definition Multimedia Interface) standard specifies a set of standards for transporting audiovisual data. It defines in particular an electrical and logical interface allowing a transfer of high-definition uncompressed multimedia digital data. It is these days widely used for transporting digital audiovisual data.

The HDMI cable can for example be supplied with the small terminal in the form of an extension cord. In the context of the abovementioned dongle, it is easier in some cases to connect it to such a cable, used as extension cord, than directly to the television (particularly if the HDMI socket of the television is located on the rear face). The user then benefits advantageously from an extension cord which enables him or her to connect comfortably to the HDMI port of his or her television while including the reception antenna.

According to a sixth particular implementation of the invention, which will be able to be implemented alternatively or together with the preceding ones, a system as described above is characterized in that the cable comprises the power supply medium and the communication medium and in that it is of MHL type.

Advantageously, this embodiment makes it possible to pool an audiovisual data transport and power supply cable of known type with the reception antenna in a cable of MHL type. The MHL (Mobile High-Definition Link) interface notably makes it possible to link mobile terminals to televisions and high-definition monitors. This interface was created by the consortium of the same name in 2010. The MHL interface handles several simultaneous functions, including the transfer of very high quality image and of sound in the form of uncompressed audio tracks, but also terminal recharging. It corresponds to an advance on HDMI but also makes it possible to dispense with another power source; it is therefore gradually replacing the current HDMI cables.

As previously, the MHL cable can be supplied with the terminal, for example the dongle, in the form of an extension cord. The user then advantageously benefits from an extension cord which enables him or her to connect comfortably to the MHL port of his or her television and which includes the reception antenna.

According to a seventh particular implementation of the invention, which will be able to be implemented alternatively or together with the preceding ones, a system as described above is characterized in that the cable comprises at least one antenna of Wi-Fi type.

The Wi-Fi standard is these days widely used in the form of audiovisual signal reception, in particular of streaming type. In the context of Wi-Fi radio technology, defined by the recommendation IEEE 802.1, the purely receiving part of the antenna is often reduced to a simple metal rod. It is preferable, for reception performance reasons, to replace this metal rod with a transmission cable of coaxial type and to use the metal core of the cable as reception antenna.

According to an eighth particular implementation of the invention, which will be able to be implemented alternatively or together with the preceding ones, a system as described above is characterized in that the cable comprises at least two Wi-Fi antennas of different types.

This embodiment of the invention notably makes it possible to cover different bit rates associated with the Wi-Fi standards. The term Wi-Fi in effect covers a set of standards of the specification by IEEE 802.11. A suffix in letter form differentiates the standards from one another. There are notably five different standards of different characteristics: 802.11a (5 Ghz), b (2.4 Ghz), g (2.4 Ghz), n (2.4 or 5 Ghz), ac (5 Ghz). It is particularly advantageous to benefit from two antenna cables in the main cable, preferably of different lengths for a better adaptation to different bit rates, to cover at least two Wi-Fi substandards offering different bit rates.

According to a ninth particular implementation of the invention, which will be able to be implemented alternatively or together with the preceding ones, a system as described above is characterized in that the cable comprises at least one antenna of Bluetooth type.

It will be recalled that Bluetooth is a communication standard allowing the two-way exchange of data at very short distance and using UHF radio waves. Advantageously, it can be used for specific functions which are of benefit in the case of an audiovisual equipment item/terminal: remote control signals, etc.

According to a tenth particular implementation of the invention, which will be able to implemented alternatively or together with the preceding ones, a system as described above is characterized in that the communication medium and the power supply medium are respectively included in two different cables and in that each of the two cables comprises at least one antenna.

Advantageously, this embodiment of the invention makes it possible to have two antennas in two distinct cables, a first in the power supply cable, for example of USB type, and a second in the communication cable, for example of HDMI type, which can be used if the reception quality is inadequate. In effect, as is known, two antennas correctly designed and positioned are capable of supplying a better signal (and therefore, for broadcast multimedia content, a better bit rate) than just one. According to this embodiment, the two antennas can be positioned independently, since they are located in two different cables.

According to an eleventh particular implementation of the invention, which will be able to be implemented alternatively or together with the preceding ones, a system as described above is characterized in that the terminal further comprises an antenna internal to said terminal.

Advantageously, this embodiment of the invention makes it possible to have at least two antennas, on the one hand the native antenna of the small terminal, and on the other hand, the antenna (or antennas) located in the power supply cable and/or in the communication cable. The two antennas combined are, as mentioned previously, capable of supplying, by cooperation, an enhanced signal, and therefore a better bit rate than if only one antenna was used. It is thus possible to retain the advantages of the existing small terminal (with its integrated antenna) while considerably enhancing the reception quality in contexts where a higher reception quality is desired.

According to a twelfth particular implementation of the invention, which will be able to be implemented alternatively or together with the preceding ones, a system as described above is characterized in that it further comprises a module for selecting an antenna.

The antenna selection module is designed to select, according to case, one or other of the two or even more antennas. This particular feature is of particular interest in the case where the reception requires the active presence of several antennas (internal and/or external), or when a problem occurs on the external antenna (offering, in this case, the possibility of activating the internal antenna, even if it offers a degraded signal reception, while awaiting resolution of the problem on the external antenna).

According to another hardware aspect, the invention also relates to a cable comprising:
a power supply medium capable of transporting an electrical power supply to a terminal and/or a communication medium capable of exchanging data with a playback device;
an antenna capable of transporting data to the terminal;
a connector for connecting it to the terminal,
   the cable being characterized in that it further comprises said antenna and in that the antenna is electrically independent of the connector.

All the advantages mentioned previously for the system apply also to the cable.

Advantageously, this type of cable can be supplied in the form of an extension cord (HDMI, MHL, etc.) with the small module. It can measure a few centimeters, typically fifteen or so, to offer a good reception quality while simplifying the connection of the key to the back of the television.

The invention will be better understood on reading the following description, given as an example and with reference to the attached drawings.

### THE FIGURES

FIG. 1 represents the general context of the invention.

FIG. 2 represents a system according to a first embodiment of the invention.

FIG. 3 represents a system according to a second embodiment of the invention.

FIG. 4 represents a hardware architecture of a terminal of reduced size, according to an embodiment of the invention according to FIG. 2 or to FIG. 3.

FIG. 5 represents a cable according to an implementation of the invention.

FIG. 6 represents a system according to a third embodiment of the invention.

FIG. 7 represents a hardware architecture of a terminal of reduced size, according to an embodiment of the invention according to FIG. 6.

FIG. 8 represents an example of connections for a cable according to an implementation of the invention.

### DETAILED DESCRIPTION OF AN EXAMPLE OF EMBODIMENT ILLUSTRATING THE INVENTION

FIG. 1 represents the general context of the invention.

A terminal device (1) is connected, in this example, on the one hand to a television (3) and on the other hand to the service gateway (6) of a local area network (not represented).

A terminal device, or more simply a “terminal”, should be understood to be any device capable of connecting to a service gateway (6), such as a Smartphone, a PDA (Personal Digital Assistant), a dongle (1) for downloading audiovisual contents or, more generally, any device capable of communicating wirelessly, in Wi-Fi mode, with the service gateway. Of these terminals, priority is given here to those of small size. Hereinbelow, the terminal according to the different embodiments takes the form of a dongle connected to a video port of the television (3), in this example a port of MHL type. This small terminal (1) is also capable of setting up connections with the service gateway linked also to the wide area network (WAN, by contrast to a local area network of LAN type). The wide area network contains a multimedia content server (not represented) which notably hosts audiovisual contents to be made available to the terminals of the local area network. The dongle can, via the gateway (6), connect to the content server of the WAN, from which it retrieves the multimedia contents (video and/or audio) to be played back on the television (3).

The service gateway (6) comprises a Wi-Fi communication function, or access point (AP), which enables it to communicate wirelessly with the terminals of the network. This access point includes a two-way radio module for transmitting or receiving the Wi-Fi signals in the local area network.

To receive such signals, the terminal (1) must be equipped with an antenna. Rather than having it, as is usually done, inside the terminal, here it is placed in the same sheath as the cable (2).

Advantageously according to this example, the dongle is therefore is supplied in the form of an extension cord with a cable (2) which makes it possible to connect the dongle.

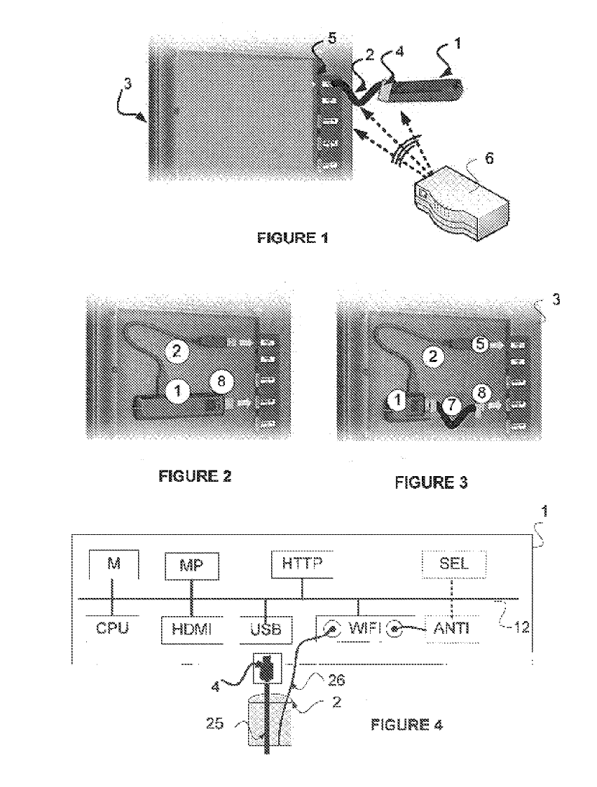

FIG. 2 represents the same system in a particular embodiment, seen from the back of the television.

According to this embodiment, the terminal or dongle (1) is connected directly to one of the HDMI ports (8) of the television (3), to which it transmits the decoded audiovisual signals.

The terminal (1), or dongle, is powered in this example via a USB cable (2) connected on the one hand to the terminal (1) and on the other hand to the television (3) via USB connectors. As is well known to those skilled in the art, the USB cable comprises a certain number of wires, including a power supply wire for the terminals which are connected to it, in this case the dongle in our example. The USB link makes it possible to power the dongle (1) simply, by exploiting the connectors available on most televisions.

According to this embodiment, the cable 2, which will be described in more detail in support of FIG. 5, comprises a “standard” USB cable, that is to say conforming to the USB standard. The USB cable has a simple structure; it comprises two pairs of wires: the signal pair, intended for the transfer of data, preferably shielded if there is a desire to minimize the interferences between the data required to pass over the USB cable and the data passing over the neighboring antenna cable, and a second pair which can be used for the power supply (“GND” and “VCC” pins of the USB standard).

In this first embodiment, the cable 2 also comprises an antenna which takes the form of a coaxial cable, therefore the core is used both for the reception and the transmission of the Wi-Fi signals.

FIG. 3 represents a system according to a second embodiment of the invention.

This embodiment differs from the preceding one in that an HDMI cable (7) is used to connect the dongle to the HDMI port (8) of the television. A second antenna (76, not represented) is associated with the HDMI cable.

This embodiment advantageously makes it possible to insert a first antenna into the USB cable and a second antenna into the HDMI cable in order to benefit from a better reception, and therefore a better bit rate for the data.

The use of an HDMI extension cord further makes it possible to connect the dongle more easily to the television.

FIG. 4 represents a hardware architecture of a terminal according to the invention.

The terminal (1) comprises memories M hinged around a CPU processor. The memories can be of ROM (Read Only Memory) or RAM (Random Access Memory) type, removable or fixed, etc. A part of the memory M stores, among other things, the identification parameters of the home gateways which the terminal can access and the identification of the terminal (for example, “dongle#2”). In our example, it is powered via a serial interface of USB type. It is powered by the USB cable (25). It communicates over the local area network by connecting wirelessly to the service gateway (6) via the Wi-Fi and HTTP modules. The antenna (26), which is located in the cable (2) according to the invention, is connected to the Wi-Fi module.

It also comprises:
an optional internal antenna ANTI connected to the Wi-Fi module;
an optional application (SEL) responsible for selecting active antennas when a number of antennas are present. This application module is notably capable of detecting which antennas are present, and of selecting the different antennas according to the needs (antenna 26 as priority, internal antenna ANTI if there is a desire to strengthen the signal and therefore have a higher bit rate, antenna 76 for the HDMI cable, etc.). The following operation can notably be envisaged for a selection method:
   1. establishment of the terminal (1) power supply;
   2. setting up of the connection to the playback device (3);
   3. detection of a first external antenna (26);
   4. detection of a second internal antenna (ANTI) or external antenna (76), and, based on the results of the detection:
      a. activation of the first antenna (26);
      b. activation of the second antenna (76) to receive a supplementing signal;
      c. activation of the third antenna (ANTI), etc.

a playback module of the “media player” (MP) type capable of playing back (receiving, decoding, preparing) the streams in streaming mode and of delivering them to the playback device (3); the “media player” comprises, among other things, a set of decoders (audio, video, etc.) capable of decoding the multimedia contents, and a communication interface with the mobile device capable of interpreting the commands from the latter (pause, rewind, volume control, etc.)

an interface module with the playback device (HDMI) capable of physically and logically interfacing with the television to transmit to it the decoded multimedia content (audio and video).

All the modules communicate conventionally with one another via a databus (12).

The cable 2 is represented by way of example on the USB input. The antenna (26) according to this example of embodiment passes into the USB connector, or alongside, and its output is recovered on the Wi-Fi module where the antenna connectors are located as identified in the figure.

FIG. 5 represents a cable according to an implementation of the invention.

The cable (2) consists of an antenna cable (26) and a power supply cable (USB 25 in the example) juxtaposed in the same sheath (24).

The antenna cable (26) is a conventional coaxial cable, made up of a main conductor wire (22) which forms the core of the antenna, an insulator (21) and a braid, or shielding (23), also conductive (ground). This cable is used to receive, emit and transmit high-frequency signals of Wi-Fi type.

The USB cable (25) is composed in this example of a two-strand conductive braid surrounded by an insulator. The presence of such an insulator improves the system by limiting the electromagnetic disturbances with the antenna cable.

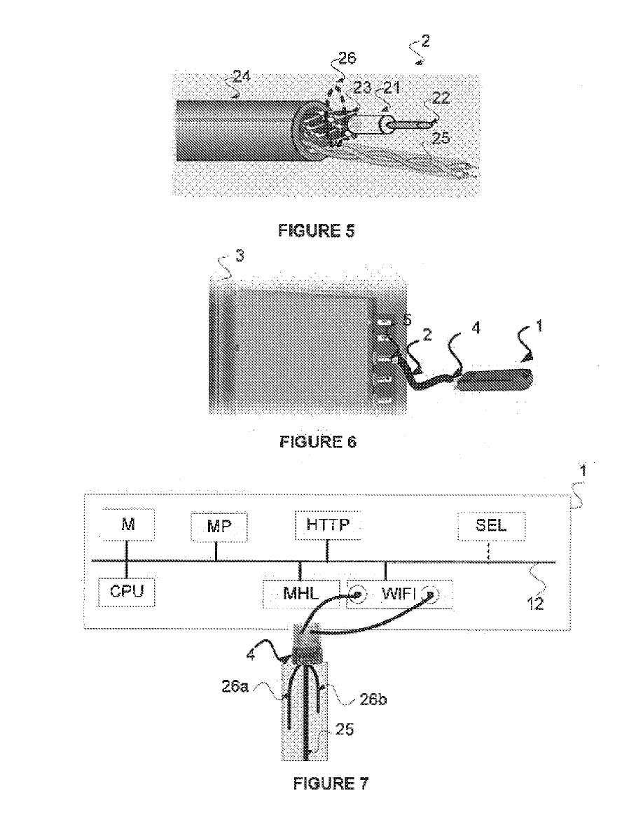

FIG. 6 represents a system according to the a third embodiment of the invention.

According to this embodiment, the terminal or dongle (1) is connected directly to one of the MHL ports (5) of the television (3), to which it transmits the decoded audiovisual signals.

The HDMI interface is evolving to new interfaces of MHL type, a set of standards that can be implemented to connect two appliances in order to handle the transmission/reception of the digital audio and video streams, notably high-definition, for example a mobile peripheral device and a television. The MHL connector handles the transfer of the audiovisual data and also makes it possible to charge the connected appliance since it has a power supply wire.

In this context, the USB power supply of FIG. 2 can be eliminated and the MHL cable replacing the HDMI cable will be able to host both the antenna according to the invention and the dongle power supply.

FIG. 7 represents a hardware architecture of a terminal of reduced size, according to an embodiment of the invention according to FIG. 6.

As already described in support of FIG. 4, the terminal (1) comprises memories M hinged around a processor CPU, a media player (MP), an optional detection module (SEL), an http module and a bus (12). It has no internal antenna.

In this example, the terminal is powered via an interface of MHL type. It communicates over the local area network by connecting wirelessly to the service gateway (6) via the Wi-Fi and HTTP modules. According to this example, two of these pins are used to run the antenna cables 26a and 26b. According to this example, one of the antennas corresponds to an 802.11a Wi-Fi mode (5 Ghz), and the other to an 802.11b type (2.4 Ghz).

The cable 26a measures approximately 17 cm; the cable 26b measures approximately 13 cm.

At the output of the connector, the two cables are redirected to the Wi-Fi module like any Wi-Fi antenna and are connected to the antenna terminals.

MHL acts also as interface module with the playback device to transmit to it the decoded multimedia content (audio and video).

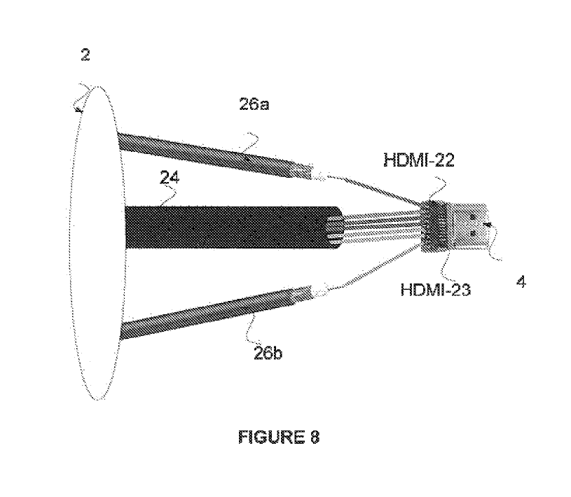

FIG. 8 illustrates the connections of an HDMI cable according to an implementation of the invention.

There are, on the HDMI support, according to the HDMI standard, a certain number of pins which are not used, either because they are reserved (pins referenced 23 and 24) or because they correspond to functions which are not used (pins 25 and 26 (SCL, SDA)).

In the example represented in FIG. 8, the pins 23 and 24 respectively denoted HDMI-23 and HDMI-24 are used to run the antenna cables 26a and 26b in the connector (4). According to this example, one of the antennas corresponds to an 802.11a Wi-Fi mode (5 Ghz), and the other to an 802.11b type (2.4 Ghz).

The original HDMI cable (24) is not modified.

It goes without saying that the embodiments which have been described above have been given in a purely indicative and nonlimiting way, and that many modifications can easily be made by a person skilled in the art without in any way departing from the scope of the invention.

For example, the invention can be applied to a radio terminal and the antenna is, in this case, an FM-radio antenna, the medium cable being able to be the power supply cable.

According to another example, the cable (2) according to the invention can be a cable of Ethernet type, the terminal (1) a router, or Wi-Fi repeater, and the wired antenna (26) is used for repeating the Wi-Fi signal to, for example, the local area network. This variant avoids adding to the Wi-Fi router metal protuberances which are generally associated with it for the reception and repeating of the Wi-Fi signals.

1. A system comprising a terminal and at least one cable
the terminal comprising:
a module configured to transmit or receive data to be played back on a playback device, said data being received or transmitted by at least one antenna;
a module configured to connect to the playback device via a communication medium capable of exchanging data with the playback device;
a module configured to connect to a power supply device via a power supply medium capable of transporting an electrical power supply, and
the cable comprising:
the communication (7) and/or power supply (2) medium;
a connector (4) for connecting the cable to the terminal, and
the at least one antenna, the antenna being electrically independent of the connector.

2. The system as claimed in claim 1, wherein the antenna is a coaxial cable.

3. The system as claimed in claim 1, wherein the length of the antenna is matched to the type of signal transported.

4. The system as claimed in claim 1, wherein the connector comprises at least one unused pin, and wherein said at least one antenna leaves the connector via the at least one unused pin before being linked to the data transmission/reception module.

5. The system as claimed in claim 2, wherein the cable is a USB cable and comprises the power supply medium.

6. The system as claimed in claim 1, wherein the cable is an HDMI cable and comprises the communication medium (24).

7. The system as claimed in claim 1, wherein the cable is an MHL cable and comprises the power supply medium and the communication medium.

8. The system as claimed in claim 1, wherein the cable comprises at least one Wi Fi antenna.

9. The system as claimed in claim 1, wherein the cable comprises at least two Wi Fi antennas of different types.

10. The system as claimed in claim 1, wherein the cable comprises at least one Bluetooth antenna.

11. The system as claimed in claim 1, wherein the communication medium (24) and the power supply medium (25) are respectively included in two different cables (2, 7) and in that each of the two cables comprises at least one antenna.

12. The system as claimed in claim 1, characterized in that the terminal (1) further comprises an antenna (ANTI) internal to said terminal.

13. The system as claimed in claim 1, characterized in that it further comprises a module (SEL) for selecting an antenna (26, 26a, 26b, ANTI).

14. A cable comprising:
a power supply medium configured to transport an electrical power supply to a terminal and/or a communication medium configured to exchange data with a playback device;
an antenna configured to transport data to the terminal;
a connector configured to connect the table to the terminal, the connector being electrically independent of the antenna.
